(19) United States
(12) Patent Application Publication
(10) Pub. No.: US 2025/0360804 A1
(43) Pub. Date: Nov. 27, 2025

(54) CONTROL LIMITS FOR VEHICLE COMBINATION UNITS

(71) Applicant: VOLVO TRUCK CORPORATION, Göteborg (SE)

(72) Inventors: Umur Erdinc, Göteborg (SE); Leo Laine, Göteborg (SE); Maliheh Sadeghi Kati, Öjersjö (SE); Christian Oscarsson, Stenungsund (SE)

(73) Assignee: VOLVO TRUCK CORPORATION, Göteborg (SE)

(21) Appl. No.: 19/190,138

(22) Filed: Apr. 25, 2025

(30) Foreign Application Priority Data
May 22, 2024 (EP) 24177253.2

(51) Int. Cl. B60L 15/38; B60L 15/20

(52) U.S. Cl. CPC B60L 15/38; B60L 15/20; B60L 2240/12; B60L 2240/421; B60L 2240/461

(57) ABSTRACT

A computer system has processing circuitry to acquire a longitudinal velocity of a vehicle combination comprising a tractor unit and at least one trailing unit; and determine an upper limit and/or a lower limit for a control parameter for at least one unit of the vehicle combination based on the acquired longitudinal velocity; and transmit the upper and/or lower limit to a controller of the at least one unit of the vehicle combination.

### TECHNICAL FIELD

The disclosure relates generally to vehicle control. In particular aspects, the disclosure relates to control limits for vehicle combination units. The disclosure can be applied in heavy-duty vehicles, such as trucks, buses, and construction equipment. In particular, the disclosure can be applied in multi-unit vehicle combinations with distributed propulsion and energy storage. Although the disclosure may be described with respect to a particular vehicle, the disclosure is not restricted to any particular vehicle.

### BACKGROUND

In vehicle motion management, control of multi-unit vehicle combinations is challenging due to the complexity of coordinating and manoeuvring multiple vehicle units together. Unlike single vehicles, these vehicle combinations require careful consideration of each vehicle unit's dynamic and the interaction between them. These multi-unit configurations often exhibit complex interactions, such as inter-vehicle communication, varying states, and dynamic behaviours. Hence, there is a need for an advanced approach to ensure safe and precise control for multi-unit vehicle combinations.

It is therefore desired to develop a solution for vehicle motion management that addresses or at least mitigates some of these issues.

### SUMMARY

This disclosure provides systems, methods and other approaches for controlling motion of a vehicle combination. In particular, a longitudinal velocity of the vehicle combination is acquired. Based on the acquired longitudinal velocity, respective upper and lower limits for a control parameter for each unit of the vehicle combination are determined. In this way, control of the vehicle combination is provided on a unit-level, which enables safe and precise control for multi-unit vehicle combinations. For example, different limits can be set for different units, enabling enhanced control such as stretch braking and roll-over prevention, and allowing different side slip angles of different units to be taken into account.

According to a first aspect of the disclosure, there is provided a computer system comprising processing circuitry configured to acquire a longitudinal velocity of a vehicle combination, determine an upper limit and/or a lower limit for a control parameter for at least one unit of the vehicle combination based on the acquired longitudinal velocity, and transmit the upper and/or lower limit to a controller of the at least one unit of the vehicle combination.

The first aspect of the disclosure may seek to provide a control system for a vehicle combination that enables different limits to be set for different units, which may be advantageous in some particular scenarios. For example, by setting different limits for different units, enhanced control such as stretch braking and roll-over prevention is enabled, and different side slip angles of different units may be taken into account. This helps to ensure safe and precise control for multi-unit vehicle combinations.

Optionally in some examples, including in at least one preferred example, the acquired longitudinal velocity is the longitudinal velocity of the tractor unit of the vehicle combination. A technical benefit may include that different units can be controlled relative to the longitudinal velocity of the tractor unit, enabling instabilities such as rollover and jack-knife to be prevented.

Optionally in some examples, including in at least one preferred example, the control parameter comprises a longitudinal slip associated with the at least one unit, a longitudinal velocity associated with the at least one unit, and/or a rotational speed of an electrical machine associated with the at least one unit. A technical benefit may include that the units of the vehicle combination can be controlled in a number different ways, ensuring safe and precise control.

Optionally in some examples, including in at least one preferred example, the processing circuitry is configured to determine the upper and/or lower limit based on a roll-over prevention operation for the vehicle combination. A technical benefit may include that limits can be specifically set to avoid roll-over, ensuring safe control of the vehicle combination.

Optionally in some examples, including in at least one preferred example, the processing circuitry is configured to determine the upper and/or lower limit based on a stretch braking operation for the vehicle combination. A technical benefit may include that limits can be specifically set to enable stretch braking, ensuring enabling increased stability and smoother control of the vehicle combination.

Optionally in some examples, including in at least one preferred example, the control parameter comprises a longitudinal velocity associated with the at least one unit, and an upper limit for longitudinal velocity is lower than the acquired longitudinal velocity. A technical benefit may include that stretch braking is enabled and jack-knifing may be avoided.

Optionally in some examples, including in at least one preferred example, the processing circuitry is configured to determine the upper and/or lower limit based on a side slip angle of the at least one unit. A technical benefit may include that, in the case that different units have different side slip angles, a unit exhibiting higher side slip can be controlled in a tighter manner.

Optionally in some examples, including in at least one preferred example, the processing circuitry is further configured to receive an upper and/or lower capability for the control parameter for the at least one unit of the vehicle combination from the controller of the at least one unit, and determine the upper limit and/or lower limit for the control parameter for the at least one unit of the vehicle combination based on the received capability. A technical benefit may include that the limits that are provided to the unit controller are achievable by the unit, ensuring that the intended vehicle behaviour can be realised.

Optionally in some examples, including in at least one preferred example, the processing circuitry is further configured to receive a measured longitudinal velocity for the at least one unit of the vehicle combination from the controller of the at least one unit. A technical benefit may include that the computer system may be informed of current vehicle behaviour to enable future limits to be set accordingly.

Optionally in some examples, including in at least one preferred example, the processing circuitry is further configured to receive a previously set upper and/or lower limit for the control parameter from the controller of the at least one unit. A technical benefit may include that the computer system may be informed if the limits that were previously transmitted were in fact implemented by the unit controller, enabling any associated issues to be handled accordingly.

Optionally in some examples, including in at least one preferred example, the controller of the at least one unit of the vehicle combination is configured to transmit an upper and/or lower limit for an actuator control parameter to one or more actuators of the at least one unit based on the upper and/or lower limit for the control parameter of the unit. A technical benefit may include that different limits may be provided to different actuators of the vehicle combination, enabling the unit limits to be implemented in any suitable way.

According to a second aspect of the disclosure, there is provided a vehicle comprising the computer system of any preceding example. The second aspect of the disclosure may seek to provide a vehicle capable of setting different limits for different units, which may be advantageous in some particular scenarios. This helps to ensure safe and precise control for multi-unit vehicle combinations.

According to a third aspect of the disclosure, there is provided a computer-implemented method comprising acquiring, by processing circuitry of a computer system, a longitudinal velocity of a vehicle combination, determining, by the processing circuitry, an upper limit and/or a lower limit for a control parameter for at least one unit of the vehicle combination based on the acquired longitudinal velocity, and transmitting, by the processing circuitry, the upper and/or lower limit to a controller of the at least one unit.

The third aspect of the disclosure may seek to provide a computer-implemented method that enables different limits to be set for different units, which may be advantageous in some particular scenarios. This helps to ensure safe and precise control for multi-unit vehicle combinations.

According to a fourth aspect of the disclosure, there is provided a computer program product comprising program code for performing, when executed by processing circuitry, the computer-implemented method. The fourth aspect of the disclosure may seek to enable new vehicles and/or legacy vehicles to be conveniently configured, by software installation/update, to set different limits for different units, which may be advantageous in some particular scenarios. This helps to ensure safe and precise control for multi-unit vehicle combinations.

According to a fifth aspect of the disclosure, there is provided a non-transitory computer-readable storage medium comprising instructions, which when executed by processing circuitry, cause the processing circuitry to perform the computer-implemented method. The fifth aspect of the disclosure may seek to enable new vehicles and/or legacy vehicles to be conveniently configured, by software installation/update, to set different limits for different units, which may be advantageous in some particular scenarios. This helps to ensure safe and precise control for multi-unit vehicle combinations.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1A schematically shows a side view of a vehicle combination according to an example of the disclosure.

FIG. 1B schematically shows a top view of a vehicle combination according to an example of the disclosure.

FIG. 2 schematically shows, in terms of functional blocks, a control system for a vehicle according to an example of the disclosure.

FIG. 3 schematically shows, in terms of functional blocks, part of the control system according to an example of the disclosure.

FIG. 4is a flow chart of a computer-implemented method according to an example of the disclosure.

FIG. 5 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

Control of multi-unit vehicle combinations is challenging due to the complexity of coordinating and manoeuvring multiple vehicle units together. Unlike single vehicles, these vehicle combinations require careful consideration of each vehicle unit's dynamic and the interaction between them. These multi-unit configurations often exhibit complex interactions, such as inter-vehicle communication, varying states, and dynamic behaviours. Hence, there is a need for an advanced approach to ensure safe and precise control for multi-unit vehicle combinations.

To remedy this, systems, methods, and other approaches for controlling motion of a vehicle combination. In particular, a longitudinal velocity of the vehicle combination is acquired. Based on the acquired longitudinal velocity, respective upper and lower limits for a control parameter for each unit of the vehicle combination are determined. In this way, control of the vehicle combination is provided on a unit-level, which enables safe and precise control for multi-unit vehicle combinations. For example, different limits can be set for different units, enabling enhanced control such as stretch braking and roll-over prevention, and allowing different side slip angles of different units to be taken into account.

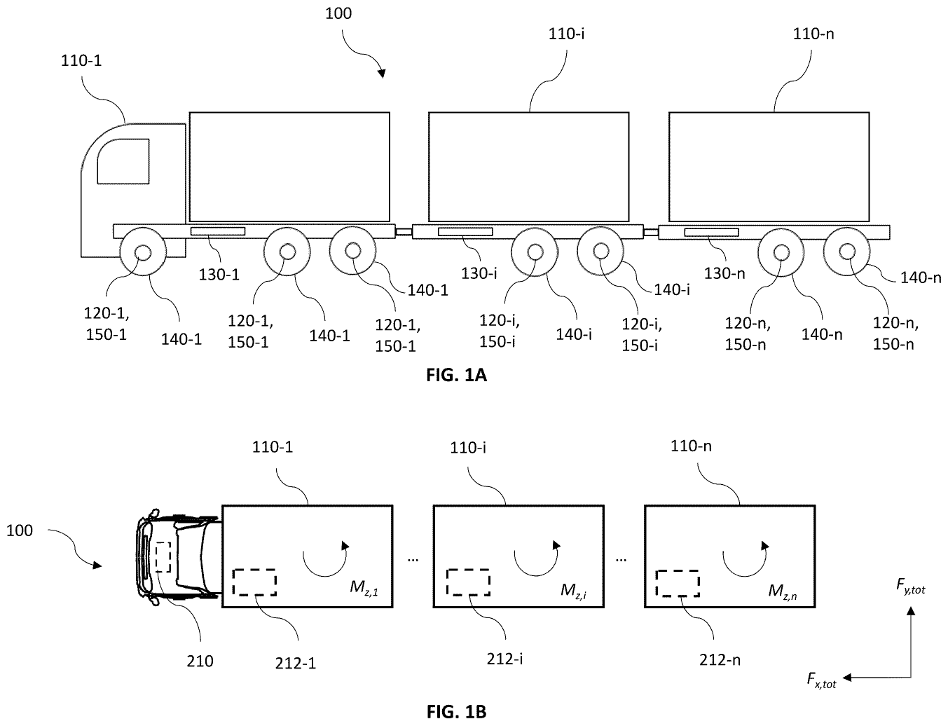

FIG. 1A schematically shows a side view of an example vehicle combination 100 of the type considered in this disclosure. The vehicle combination 100 comprises a number of units 110, including a tractor unit and at least one trailing unit. Each unit 110 may be given an index i, and the total number of units 110 in a vehicle combination 100 is designated n. Whilst two trailing units are shown, it will be appreciated that the vehicle combination 100 may comprise more or fewer trailing units connected to each other. This gives rise to different types and designations of vehicle combinations.

A tractor unit, such as the tractor unit 110-1, is generally the foremost unit in a vehicle combination 100, and may comprise the cabin for the driver, including steering controls, dashboard displays and the like. Generally, the tractor unit 110-1 is used to provide propulsion power for the vehicle combination 100 In the example of FIG. 1A, the tractor unit 110-1 may also be used to store goods that are being transported by the vehicle combination 100 A tractor unit may also be referred to as a truck.

A trailing unit, such as the trailing units 110-i, 110-n, is generally used to store goods that are being transported by the vehicle combination 100 A trailing unit may be a trailer, dolly and the like. A trailing unit may also provide propulsion to the vehicle combination 100 A trailing unit without a front axle, such as the trailing units 110-i, 110-n is known as a semi-trailer. In vehicle combinations such as that shown in FIG. 1A, vehicle motion management is available on a unit level to receive requests from a manual or virtual driver to coordinate the propulsion, braking and steering.

Whilst three tractor axles and two axles per trailer are shown, it will be appreciated that any suitable number of axles may be provide on the respective units 110 It will also be appreciated that any number of the tractor axles and/or trailer axles may be driven axles, including zero (i.e. one of the units may include at least one driven axle while the other does not).

The vehicle combination 100 may comprise one or more sources or propulsion. For example, one or more of the units 110 may comprise one or more electrical machines 120 such as electric motors. Each unit 110 may comprise one or more batteries 130 configured to provide power to the electrical machines 120 A vehicle combination 100 that uses only battery power is a battery electric vehicle (BEV). In some examples, for example in the case of a hybrid electric vehicle (HEV), a unit 110, most often a tractor unit 110-1 may also include another source of propulsion, for example an internal combustion engine (ICE). The vehicle combination 100 also comprises a drivetrain (not shown) to deliver mechanical power from the propulsion source (the electrical machines 120 or the ICE) to the wheels 140 All units 110 may provide propulsion to the vehicle combination 100 In the examples discussed herein, the vehicle combination 100 may be a BEV or an HEV.

The electrical machines 120 are configured to drive, e.g. provide torque and/or steering to, one or more axles or individual wheels 140 of the unit 110 The electrical machines 120 of a unit 110 can supply either a positive (propulsion) or negative (braking) force. In some examples, electric motors may also be operated as generators, in order for the electric motors to generate braking force when required. The use of electrical machines 120 to supply a negative force is known as regenerative braking. The energy recovered from regenerative braking can be stored in the batteries 130, and so regenerative braking is generally preferred over using service brakes 150

Furthermore, each unit 110 may comprise one or more sets of service brakes 150 The service brakes 150 of a unit 110 can supply a negative (braking) force. The service brakes 150 may be, for example, frictional brakes such as pneumatic brakes. Pneumatic brakes use a compressor to fill the brake with air, which may be powered by the batteries 130 In some examples, the brakes may be electro-mechanical brakes or hydraulic brakes.

The vehicle combination 100 may also comprise one or more auxiliary systems (not shown). The auxiliary systems may include auxiliary mechanical systems, such as alternators, power take-off (PTO) systems, and an air compressors, and auxiliary electrical systems, such as steering pumps, headlights, other light systems, ignition systems, audio systems, and air conditioning systems.

The ICE, electrical machines 120 and service brakes 150 are considered as actuators of the vehicle combination 100 Other actuators may also be present. For example, steering actuators 150, such as steering servo arrangements, may be provided, and may be implemented as electro-hydraulic actuators. Each actuator in a given unit 110 may be given an index k, and the total number of actuators in a given unit 110 is designated m. It will be appreciated that each axle and/or wheel 140 may have an associated electrical machine 130, set of service brakes 150, and/or set of steering actuators.

The vehicle combination 100, or indeed one or more (e.g. each) units 110, can be considered to comprise two systems: a propulsion system comprising the components that are involved in propulsion of the vehicle combination 100, and a braking system comprising the components that are involved in braking of the vehicle combination 100 As such, the propulsion system can be considered to comprise one or more of the ICE, electrical machines 120, the drivetrain, and batteries 130 of the vehicle combination 100, while the braking system can be considered to comprise the ICE, the electrical machines 120, the drivetrain, the batteries 130, and the service brakes 150 As such, there is some overlap between the propulsion system and the braking system.

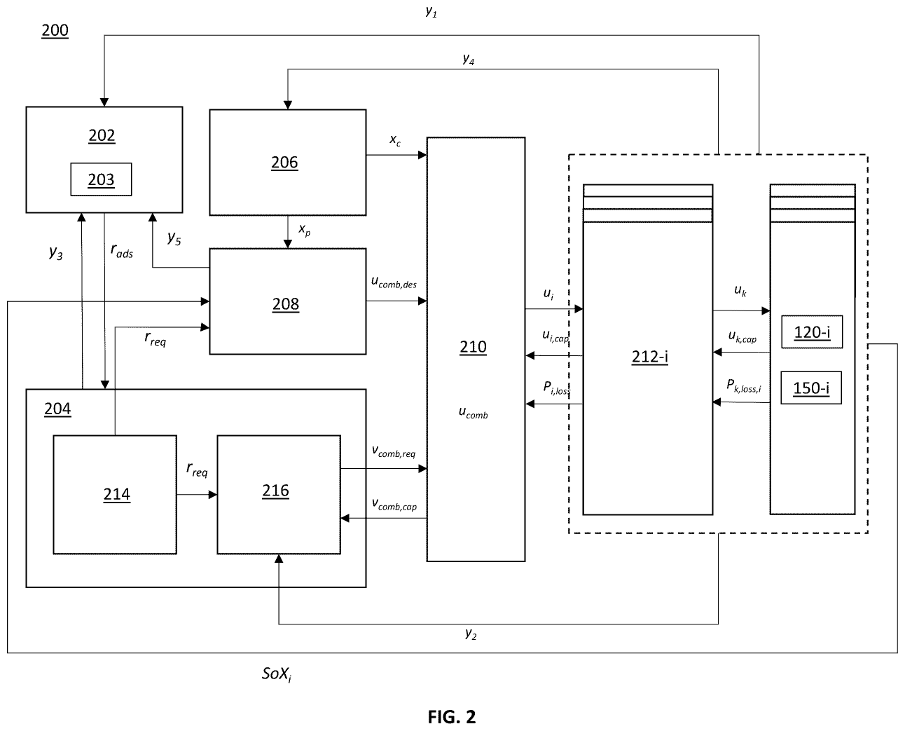

FIG. 1B schematically shows a top view of an example vehicle combination 100 of the type considered in this disclosure. Similarly to the example of FIG. 1A, the vehicle combination 100 comprises a number of units 110, including a tractor unit and a plurality of trailing units. FIG. 1B also shows the requested global forces of the vehicle combination 100 as a whole. Examples of requested global forces of the vehicle combination 100 as a whole may e.g. include a total longitudinal/axial force F_{x,tot} a total lateral/radial force F_{y,tot,} and/or one or more yaw moments M_{z,i} for the respective vehicle units 110 In order to control motion of a vehicle combination 100, the requested global forces of the vehicle combination 100 must be determined and resolved. This may be achieved by a control system 200 (shown in FIG. 2) of the vehicle combination 100 that determines control signals based on a requested reference input and certain operating conditions of the vehicle combination 100

In the example of FIG. 1B, the vehicle combination 100 includes a combination control allocator 210 and a plurality of unit control allocators 212 The combination control allocator 210 and the various unit specific control allocators 212 together form a distributed control allocation system for the vehicle combination 100 In this system, the control allocation may be performed on multiple levels, i.e. first on a level of the vehicle combination 100 as a whole, and then on a level of each vehicle unit 110 individually. The combination control allocator 210 may be provided (as shown) as part of the tractor unit 110-1 while the unit control allocators 212 are provided as part of each individual unit 110 It will be appreciated that the combination control allocator 210 may be provided as part of any unit 110 of the vehicle combination 100

FIG. 2 schematically shows, in terms of functional blocks, an example control system 200 for a vehicle, such as the vehicle combination 100 The control system 200 serves to perform various functions of the vehicle combination 100, such as power management and motion coordination. The control system 200 comprises a tactical layer 202, a target generator 204, a state estimator 206, an energy manager 208, a combination control allocator 210 and a plurality of unit control allocators 212 The combination of the target generator 204, the state estimator 206, and the energy manager 208, may be referred to as a vehicle motion controller (VMC) of the vehicle combination 100 The various modules may e.g. be implemented as code running on a processing circuitry, or similar. The various modules may comprise processing circuitry configured to implement various operations disclosed below. The various modules may include a memory storing instructions that, when executed by the processing circuitry, cause the processing circuitry to perform the various operations. The various modules may be communicatively connected or connectable to each other, for example as known in the art.

The tactical layer 202 is responsible for ensuring that the trajectory for the whole combination 100 is obstacle free and collision free. The tactical layer 202 may also be referred to as an automated driving system (ADS) of the vehicle combination 100 For example, the tactical layer 202 may determine a trajectory for the vehicle combination 100 that ensures that a swept path of the vehicle combination 100 and the individual units 110 is safe and achievable. To this end, the tactical layer 202 may provide an input r_{ads} relating to a manoeuvre in an autonomous driving case. The input r_{ads} may include requests such as target distance, velocity, acceleration, and curvature (steering) for the vehicle combination 100 These may be scalar values or vectors with evolutions for a given prediction horizon. The tactical layer 202 may also send determined future performance limits for the vehicle combination 100

The tactical layer 202 may also send requests for power and energy management to optimize range and mission performance. For example, the tactical layer 202 may also include predictive energy management, including battery targets, capabilities and statuses that determine how the energy sources of the vehicle combination 100 should be used for a whole mission. To this end, the tactical layer 202 may receive a model of the power flows of the vehicle combination 100 from the VMC, in particular the energy manager 208, as will be discussed below.

In some examples, the tactical layer 202 comprises a vehicle model 203. The vehicle model 203 is a model of the vehicle combination 100 intended to plan trajectories of the vehicle combination 100 As such, the vehicle model 203 can be used to determine the input r_{ads}. The vehicle model 203 may include different parameters of the vehicle combination 100 such as capabilities, structural parameters, and dynamic parameters of the vehicle combination 100, and be capable of determining the forces acting on the vehicle combination 100 The vehicle model 203 can be any suitable model, for example a model known in the art. The vehicle model 203 can be based on real tests, computer model simulations, a machine-learning model, or other suitable means known in the art. The vehicle model 203 may be, for example, a single-track model (i.e., left and right wheels on a given axle are considered together), such as a bicycle model. The vehicle model 203 may alternatively be a more complex model such as a dual track model (i.e., left and right wheels on a given axle are considered separately). The real units can have axle groups with several axles, but in the model they may be considered together. A tyre model can be used in combination with the vehicle model 203. The tyre model may take into account the cornering stiffness of the tyres of the vehicle combination 100 The vehicle model 203 may be configured to operate within an agreed operational design domain (ODD) and a specified safe operating envelope (SOE) for the vehicle combination 100. The vehicle model 203 may therefore include vehicle motion management logic that includes capabilities of the vehicle combination 100 and the SOE to avoid instabilities such as rollover, jack-knife, and/or an unsafe swept path width.

The vehicle model 203 may be time-invariant or time variant, based on certain parameters of the vehicle combination 100 To this end, the tactical layer 202 may receive parameters y₁ of the vehicle combination 100 from the vehicle combination 100 and/or the individual units 110 The parameters y₁ may include capabilities, structural parameters, and/or dynamic parameters of the vehicle combination 100

The vehicle capabilities comprise at least one of a maximum range capability, a maximum operational time capability, a longitudinal acceleration minimum, a longitudinal acceleration maximum, a longitudinal acceleration rate minimum, a longitudinal acceleration rate maximum, a longitudinal velocity minimum, a longitudinal velocity maximum, a longitudinal distance minimum, a longitudinal distance maximum, a yaw rate minimum, a yaw rate maximum, a yaw acceleration minimum, a yaw acceleration maximum, a longitudinal velocity maximum for uphill slopes, and a longitudinal velocity maximum values for downhill slopes. While the maximum range capability relates to total distance that the vehicle can travel, the longitudinal distance minimum/maximum refers to a relatively short distance, for example for shunting in a logistic context for moving a vehicle in a yard, or for a safe stop.

In some examples, the capabilities are functions of capability parameters. For example, the longitudinal acceleration minimum and/or the longitudinal acceleration maximum may be a function of one or more of a longitudinal velocity of the vehicle combination 100, a mass of the vehicle combination 100, a lateral acceleration of the vehicle combination 100, a turning radius of the vehicle combination 100, a longitudinal force provided by the electrical machines 120, and/or a thermal property of one or more batteries 130 In some examples, the longitudinal force provided by the electrical machines 120 is a function of thermal properties of the electrical machines 120, as the power capabilities of the electrical machines 120, and consequently the longitudinal force capabilities, will be a function of motor temperature. Similarly, the capability of the batteries 130 depends on thermal properties of the batteries 130

Furthermore, the thermal properties of the batteries 130 may limit performance of the electrical machines 120 in the case that the battery power limits the electrical machine power and the electrical machines 120 can only provide a certain torque. The vehicle capabilities may also be influenced by a thermal mode requested by the tactical layer 202 as discussed further below.

The structural parameters of the vehicle combination 100 comprise at least one of a type of the vehicle combination 100, a number of units 110 of the vehicle combination 100, a number of axles in each unit 110, a tyre type in each axle group, a distance of each axle of each unit 110 to the first axle and coupling points of the unit 110, the number of steered axles in each unit 110, the number of propelled axles in each unit 110, the number of liftable axles in each unit 110, nominal diameters of the wheels 140, a track of each axle, a mass of the unladen vehicle combination 100, and a centre of gravity of the unladen vehicle combination 100 The type of the vehicle combination 100 may be defined by different types of coupling used in the vehicle combination 100 The tyre type may be defined by a tyre stiffnesses, a peak friction/slip parameter of the tyre, and/or other parameters used in known tyre models such as the Pacejka Magic Formula or a brush model.

The dynamic parameters of the vehicle combination 100 comprise at least one of a mass of each unit 110, a load on each axle, an inertia of each unit 110, a lumped cornering stiffness of each axle, a rolling resistance of each axle, a distance of a dynamic centre of gravity from the first axle of each unit 110, and an air drag property. The inertia may be expressed in three directions, although the vertical direction is most relevant for trajectory planning as it represents the yaw moment of inertia, which is relevant for the yaw-plane motion of the vehicle combination 100 The air drag property may include am effective surface of the vehicle combination 100 for different wind directions.

Based on these received parameters y₁ of the vehicle combination 100, the vehicle model 203 can be updated to reflect the current state of the vehicle combination 100 This can be advantageous in autonomous driving of multi-unit vehicle combinations, as it may enable safe and precise trajectory planning, which is not trivial due to the complexity in their dynamics and interactions between units 110 For instance, an updated vehicle model 203 can enable a swept path of both the vehicle combination 100 and individual units 110 to be maintained within a safe range. Other typical use cases for the vehicle model 203 include overtake situations on uphill for the vehicle combination 100, where the vehicle model 203 can determine whether the vehicle combination 100 has sufficient motion capabilities for a successful overtake. Additionally, the vehicle model 203 can be applied to assess rough timing, determining how long the vehicle combination 100 can be used.

In some examples, the tactical layer 202 can decide on state of charge (SoC) targets for the batteries 130 of the vehicle combination 100 as a function of distance, in some cases considering slope changes, etc. For example, the tactical layer 202 can request the battery 130 of a unit 110 having a higher SoC be drained for an uphill slope, as it can foresee that batteries 130 of all units 110 can be charged fully with regenerative braking at a following downhill slope. In some examples, an SoC controller (not shown) can calculate weighting factors for SoC targets. In some examples, the tactical layer 202 can send targets for the state of energy rate (S\dot{o}E) directly to the combination control allocator 210

Furthermore, the tactical layer 202 can request the transfer of energy from one unit 110 to another by means of propulsion in one unit 110 and regenerative braking in the other (as explained in WO 2021/180300 A1 in the name of Volvo Truck Corporation). In another example, the tactical layer 202 requests the battery 130 of a unit 110 be drained faster than another based on the number of available chargers in a following charge station or due to equalizing the charging time of all units 110 or minimizing the total charging time at the charging station.

The tactical layer 202 can also be used to select an operating mode (otherwise known as a thermal management mode) for the vehicle combination 100 A vehicle combination 100 may be capable of operating in a number of different modes dependent on desired performance. It is advantageous to provide smart electric vehicle units that can provide different settings or automatically detect which operating mode is most suitable for durable and/or efficient driving. The tactical layer 202 can select an operating mode based on factors such as current traffic situation, road types, GPS signals, weather conditions, or a vehicle usage preference (a preferred driving scenario for example long distance, short distance usage, etc.). The tactical layer 202 can also select an operating mode based on real time data from the vehicle sensors, or vehicle-to-vehicle/infrastructure communication data. For example, if it is determined that a quick acceleration or high performance is needed based on this data (e.g. due to changes in traffic conditions), the tactical layer 202 can select an operating mode accordingly. The operating modes may include an “Eco” mode or “Range” mode, in which acceleration and top speed of the vehicle combination 100 can be limited to optimise energy efficiency and maximise range, an “Endurance” mode, intended to enable a vehicle combination 100 to operate for a long duration, a “Performance” mode, configured to provide maximum acceleration and top speed, and an “I-know” mode, in which pre-set configurations for the vehicle combination 100 can be adjusted appropriate to desired performance.

The tactical layer 202 can interface with vehicle motion management components of the control system 202, in particular the target generator 204. As discussed above, the tactical layer 202 may provide an input r_{ads} relating to a manoeuvre to the target generator 204 In some instances, the input r_{ads} may be determined by the vehicle model 203 based on the current parameters y₁ received from the vehicle combination 100 This interface ensures that motion in a reference coordinate system can be requested by the tactical layer 202 within the capabilities of the vehicle combination 100 to ensure safe and efficient motion control. This enables fully automated driving with redundancy and vehicle safety.

The purpose of the target generator 204 is to determine a requested reference input r_{req} and a requested combination control input V_{comb,req} for the vehicle combination 100 The requested reference input r_{req} is determined based on an input related to a manoeuvre for the vehicle combination 100, for example the input r_{ads} from the vehicle model 203 of the tactical layer 202 and represents a requested movement of the vehicle combination 100 The requested combination control input V_{comb,req} can be determined based on the requested reference input r_{req} and/or the input r_{ads}. The requested combination control input V_{comb,req} can also be determined based on a motion capability V_{comb,cap} for the vehicle combination 100 The target generator 204 comprises a path planner/controller 214 and a force generator 216

In particular, the target generator 204 may receive an input related to a manoeuvre for the vehicle combination 100 The manoeuvre may be, for example, straight-line driving, cornering, braking and the like. The target generator 204 may receive data from, for example, a steering wheel and/or gas/brake pedal of the combination 100, indicating that the driver (or some other system of the vehicle combination 100) wants to change the direction and/or the speed of the vehicle combination 100 in a certain way. This may be the case in a semi-autonomous driving scenario. In some examples, the input may originate from elsewhere, for example any other system that may provide some indication of how the overall forces of the vehicle combination 100 are to be influenced (e.g. steered, propelled or braked). For example, the data may originate from a lane assist system, a lane following system, an emergency steering system, an emergency braking system, an automated or semi-automated drive system. In one particular example, the target generator 204 may receive the input r_{ads} from the vehicle model 203 of the tactical layer 202 This may be the case in a fully autonomous driving scenario. Based on this input, the target generator 204 may output a requested reference input r_{req}. In particular, the path planner/controller 214 determines the requested reference input r_{req}. The requested reference input r_{req} may comprise at least one of a longitudinal acceleration aₓ of the vehicle combination 100 as a whole or of a unit 110 of the vehicle combination 100 (for example the unit 110 comprising the combination control allocator 210), a longitudinal velocity Vₓ₁ of a tractor unit 110-1, a lateral velocity v_{y1} of the tractor unit 110-1, a yaw rate ω_{zi} of at least one unit 110 of the vehicle combination 100, and a steering angle δ_{f,req} of the tractor unit 110-1 In some examples, the target generator 204 may also receive determined future performance limits for the vehicle combination 100

The requested combination control input V_{comb,req} is determined by the force generator 216 The requested combination control input V_{comb,req} can be determined based on the requested reference input r_{req}, or based on the input r_{ads} directly. In the latter case, the path planner/controller 214 can be used to determine a requested reference input r_{req} for shorter term motion, for example by up-sampling the requests r_{ads} from the tactical layer 202 that may be sent infrequently (e.g. every second or so). The requested combination control input V_{comb,req} may include requested motion parameters for the vehicle combination 100. In particular, the forces F_{tot,req} and/or moments M_{z,tot,req} that need to be applied to the vehicle combination 100 as a whole in order to follow the requested reference input r_{req} are determined. The requested motion parameters included in the requested combination control input V_{comb,req} of the vehicle combination 100 may comprise at least one of a requested longitudinal force F_{x,tot,req} of the vehicle combination 100, a requested lateral force F_{y,tot,req} of the vehicle combination 100, a requested longitudinal coupling force F_{cxi,req} between consecutive units 110, and a requested lateral coupling force F_{cyi,req} between consecutive units 110 These make up the total requested force to be applied F_{tot,req} for the vehicle combination 100 The motion parameters included in the requested combination control input V_{comb,req} of the vehicle combination 100 may also comprise a requested yaw moment M_{z,i,req} for one or more units 110

The requested combination control input V_{comb,req} may also be determined based on state information y₂ from the different units 110 of the vehicle combination 100 and a motion capability V_{comb,cap} for the vehicle combination 100 The state information y₂ may include information from sensors of the vehicle combination 100 such as wheel speed sensors, inertial measurement units, articulation angle sensors and the like. The motion capability V_{comb,cap} of the vehicle combination 100 may describe the limits of motion parameters for safe operation of the vehicle combination 100 The motion capability V_{comb,cap} may comprise at least one of a longitudinal force capability F_{x,tot,cap} of the vehicle combination 100, a lateral force capability F_{y,tot,cap} of the vehicle combination 100, and a yaw moment capability M_{z,i,cap} for one or more units 110 The state information y₂ may also include structural parameters of the vehicle combination 100 as discussed above in relation to parameters y₁.

The requested combination control input V_{comb,req} may be determined based on a vehicle model. The vehicle model can be any suitable model, for example a model known in the art. The model can be based on real tests, computer model simulations, a machine-learning model, or other suitable means known in the art. The vehicle model may provide motion prediction of the vehicle combination 100 by looking at previous steering input and acceleration input. The prediction may include instabilities such as understeer or rollover risk, for example within a one-second horizon. The model may be, for example, a single-track model, i.e., left and right wheels on a given axle are considered together. The real units can have axle groups with several axles, but in the model they are considered together. A tyre model can be used in combination with the vehicle model. The tyre model may take into account the cornering stiffness of the tyres of the vehicle combination 100

The target generator 204 may also be configured to send stability information y₃ to the tactical layer 202 The stability information y₃ may include constraints associated with an SOE of the vehicle combination 100 to avoid instabilities such as rollover, jack-knife, and/or an unsafe swept path width.

The state estimator 206 is responsible for processing state information y₄ from the different units 110 of the vehicle combination 100. For example, the state estimator 206 may receive information from sensors of the vehicle combination 100 such as wheel speed sensors, inertial measurement units, articulation angle sensors and the like and use this information to determine states for the vehicle combination 100 and the various units. The state estimator 206 may then output unit-specific state information xₚ to the energy manager 208 and unit-specific state information x_{c} to the combination control allocator 210

The energy manager 208 determines a power split between the different units 110 of the vehicle combination 100 The energy manager 208 may also determine a power split within each unit 110, meaning how the power demand is divided between the actuators (for example, the ICE, the electrical machines 120, service brakes 150, and/or steering actuators) of the unit 110 Inputs to the energy manager 208 include the requested reference input r_{req} from the target generator 204 and the statuses SoX of the batteries 130 of the vehicle combination 100 The energy manager 208 determines a power allocation and an associated power allocation input U_{comb,des}. The power split may be determined based on the state of energy rate (S\dot{o}E) for each unit 110 and/or the longitudinal part of the requested force for the unit's propulsion system F_{xpi,req}. The energy manager 208 may consider factors that affect long-term energy consumption, such as road slopes, SoC states, charger locations, and the like, and determine power behaviour as a function of the energy over time. The energy manager 208 may also be configured as a power manger. For example when a time horizon is considered, it may handle energy. When instantaneous values are considered, it may handle power.

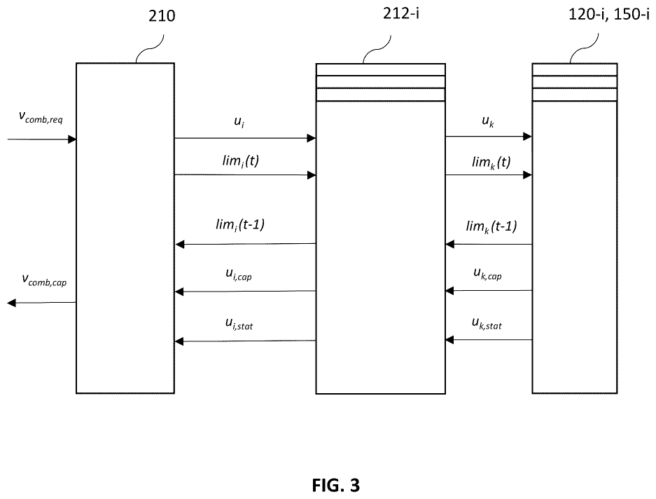

The energy manager 208 may also be configured to send power information y₅ to the tactical layer 202 The power information y₅ may include a representation of the power flows of the vehicle combination 100 The representation may be determined using a directed graph that represents power flows between the different energy system components of the vehicle combination 100, such as the electrical machines 120, batteries 130, wheels 140, service brakes 150, auxiliary mechanical systems, and auxiliary electrical systems. This may then be represented as a matrix, for example an incidence matrix. The power information y₅ may include capabilities associated with the power flows. In this way, the energy manager 208 may provide a flexible and scalable power flow model of the vehicle combination 100 to the tactical layer 202 The determination of the representation of the power flows of the vehicle combination 100 will be discussed in more detail in relation to FIGS. 3 to 5 The power information y₅ may also include structural parameters received from the target generator 204 and statuses SoX of the batteries 130

Based on these values, the control allocators 210, 212 may determine control data that meets the requested global forces of the vehicle combination 100 to meet certain constraints, such as power management (optimising battery usage) and safety constraints (ensuring that the trajectory for the whole combination 100 is obstacle free and collision free). In particular, the control allocators 210, 212 determine how various actuators (for example, the ICE, the electrical machines 120, service brakes 150, and/or steering actuators) of the vehicle combination 100 are to be controlled in order to generate requested global forces of the vehicle combination 100 as a whole. The combination control allocator 210 and the various unit specific control allocators 212 together form a distributed control allocation system for the vehicle combination 100 In this system, the control allocation is performed on multiple levels, i.e. first on a level of the vehicle combination 100 as a whole, and then on a level of each vehicle unit 110 individually.

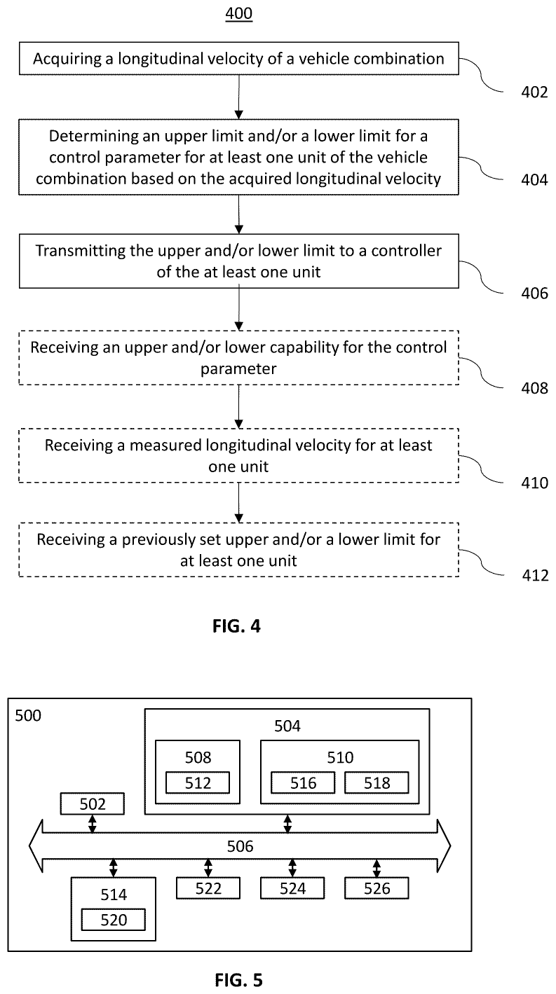

The combination control allocator 210 transforms the requested combination control input V_{comb,req} from the target generator 204 into an allocated combination control input U_{comb} for the vehicle combination 100, describing appropriate motion parameters for each unit 110 The allocated combination control input u_{comb} of the vehicle combination 100 comprises the forces F and/or moments M to be applied for the vehicle combination 100 The allocated combination control input u_{comb} comprises allocated unit control inputs uᵢ describing the forces and/or moments that each respective unit 110 is to produce in order to provide the allocated combination control input u_{comb} of the vehicle combination 100 The allocated unit control inputs uᵢ may comprise a force control input for the unit's propulsion system Fₚᵢ, and a force control input for the unit's braking system F_{bi}. The allocated unit control inputs uᵢ are transmitted from the combination control allocator 210 to the respective unit control allocators 212 In addition, the combination control allocator 210 may also transmit upper and lower limits for a control parameter of a unit 110 to the respective unit control allocators 212 as will be discussed below in relation to FIGS. 3 and 4

The unit control allocators 212 comprise a specific control allocator 212 for each unit 110 of the vehicle combination 100 The unit-specific allocated control inputs uᵢ that are output from the combination control allocator 210 are transformed into actuator-specific allocated control inputs uₖ by the unit-specific control allocators 212 The actuator-specific allocated control inputs uₖ describe actual commands for the actuators of a unit, for example, the ICE, the electrical machines 120, service brakes 150, and/or steering actuators of the unit 110 For example, the unit-specific control allocators 212 map the forces and moments of each unit 110 into the steering and drive/brake torques to be applied at the wheels of each unit 110 To do this, the unit control allocators 212 may determine a requested force control input for the unit's propulsion system Fₚᵢ and a requested force control input for the unit's braking system F_{bi}. The unit control allocators 212 then determine the actuator-specific allocated control inputs uₖ accordingly, which comprise allocated force control inputs for the individual actuators of the unit's different systems: Fₚₖ for the actuators of the propulsion system, and F_{bk} for the actuators of the braking system. The actuator-specific allocated control inputs uₖ are transmitted from the respective unit control allocators 212 to the respective actuators of the unit 110 In addition, the unit control allocators 212 may also transmit upper and lower limits for a control parameter of an actuator to the respective actuator, as will be discussed below in relation to FIGS. 3 and 4

In some examples, each unit 110 may be capable of estimating its own capabilities U_{i,cap}, e.g. how much and/or how fast the unit 110 can move at a current time instant. The unit capabilities comprise a force capability for its propulsion system F_{pi,cap} and a force capability for its braking system F_{bi,cap}. This may be based on an actuator capability U_{k,cap} for each actuator, e.g. how much and/or how fast the actuator can move at a current time instant. The actuator capabilities comprise a force capability for the actuators F_{pk,cap} during propulsion and a force capability for the actuators F_{bk,cap} during braking. The actuators of each unit 110 may provide an actuator capability U_{k,cap} to the respective unit control allocator 212-i, which provides a unit capability u_{i,cap} to the combination control allocator 210 The unit capabilities U_{i,cap} may also comprise capabilities of the power input/output of the batteries 130 In addition, the unit control allocators 212 may also transmit a status of a control parameter to the combination control allocator 210 and/or a current value of the upper and lower limits for the control parameter of a unit 110 The status may include a current value of the control parameter, for example received from an actuator. This will be discussed below in relation to FIGS. 3 and 4.

Each unit 110 may also be capable of estimating its own power losses P_{i,loss}. The unit power losses P_{i,loss} comprise a power loss for its propulsion system P_{pi,loss} and a power loss for its braking system P_{bi,loss}. This may be based on an actuator power losses P_{k,loss,i} for each actuator in the unit 110 as well as other power losses in the unit 110, such as power losses in the batteries and the drivetrain. The actuator power losses P_{k,loss,i} comprise a power loss for propulsion actuators P_{pk,loss,i} (e.g. electrical machines 120, ICE, and/or other propulsion sources) and a power loss for braking actuators P_{bk,loss,i} (e.g. electrical machines 120 and/or service brakes 150). The actuators of each unit 110 may provide the actuator power losses P_{k,loss,i} to the respective unit control allocator 212-i, which provides unit power losses P_{i,loss} to the combination control allocator 210

FIG. 3 schematically shows, in terms of functional blocks, part of an example control system for a vehicle, such as the control system 200 In particular, a combination control allocator 210, unit control allocators 212 and actuators of the vehicle (e.g. electrical machines 120 and service brakes 150) are shown.

As discussed above, the combination control allocator 210 receives the requested combination control input V_{comb,req} and transforms it into allocated unit control inputs uᵢ describing the forces and/or moments that each respective unit 110 is to produce. This may be performed based on the unit capabilities u_{i,cap} received from the respective unit control allocators 212 The allocated unit control inputs uᵢ are provided to the unit control allocators 212 and transformed into actuator-specific allocated control inputs uₖ by the unit-specific control allocators 212 This may be performed based on the actuator capabilities u_{k,cap} received from the respective actuators. The actuator capabilities u_{k,cap} and the unit capabilities u_{i,cap} may also be fed back to the VMC as the motion capability V_{comb,cap} for the vehicle combination 100

The actuators may also provide actuator status messages U_{k,stat} to their respective unit control allocators 212 These may include, for example, an applied brake force for the service brakes 150 (or applied pressure for a pneumatic brake), a wheel speed (for example from wheel speed sensor that may be part of the service brakes 150), a brake disk temperature, a tyre pressure, a voltage of an electrical machine 120, a current of an electrical machine 120, a torque of an electrical machine 120, a force of an electrical machine 120, a speed of the actuator, a steering angle of the actuator (in the case of a steering servo arrangement), axle loads (or below pressures), a temperature of an ICE, a torque of an ICE, a speed of an ICE, and the like. The unit control allocators 212 may also provide unit status messages u_{i,stat} to the combination control allocator 210 These may include, for example, unit a total force of the service brakes 150 of the unit 110, a total force of the electrical machines 120 of the unit 110, a speed (longitudinal, lateral) the unit 110, and the like. In some examples, the unit status messages u_{i,stat} may include a side slip angle of the unit 110, sensor signals such as yaw rates and accelerations of the unit 110 (for example from inertial measurement units), coupling forces between units 110, a total axle load of the unit 110, a position of the centre of gravity (e.g. vertical, longitudinal) of the unit 110, and the like, which may also be provided from the state estimator 206 The unit status messages u_{i,stat} may be determined based on the actuator status messages u_{k,stat}. For example, a total force of service brakes 150 of the unit 110 may be calculated by taking a sum of the applied brake force for all of the service brakes 150 of the unit 110 Similarly, a total force of the electrical machines 120 of the unit 110 may be obtained by taking a sum of the force for all of the electrical machines 120 of the unit 110

The combination control allocator 210 is also configured to transmit upper and lower limits limᵢ for a control parameter of a unit 110 to the respective unit control allocators 212 These may be provided as requests for implementation by the unit control allocators 212 The control parameter may be a longitudinal slip associated with a unit 110, a longitudinal velocity associated with a unit 110, and/or a rotational speed of an electrical machine 120 associated with a unit 110 The unit limits limᵢ are determined based on a longitudinal velocity of the vehicle combination 100 that may be provided as part of unit status messages u_{i,stat}, as will be discussed below in relation to FIG. 4 The unit limits limᵢ may also be determined to be within the unit capabilities u_{i,cap}.

In some examples, the unit control allocators 212 may use the unit limits limᵢ in determining the actuator-specific allocated control inputs uₖ. For example, if the unit limits limᵢ comprise a longitudinal velocity for a unit 110, and if in uₖ comprises speeds/slips to be input to the actuators, the unit allocator 212 can saturate uₖ to be within limᵢ. In another example, if Uₖ comprises only forces for the actuators, the unit allocator 212 can use an inverse tire model to provide wheel force from an input as wheel speed or slip. Then, based on the unit limits limᵢ (speed or slip), corresponding maximum and/or minimum wheel forces can be determined, and the unit allocator 212 can saturate uₖ accordingly.

The unit control allocators 212 are also configured to transmit upper and lower limits limₖ for a control parameter of an actuator to the respective actuators. These may be provided as requests for implementation by the actuators. The actuator control parameters may include, a slip, a speed, a force, and/or a torque associated with an actuator. For example, for an electrical machine 120, the control parameters may include the speed of the shaft of the electrical machine 120, the speed of an associated wheel 140, the slip at an associated wheel 140, the shaft torque of the electrical machine 120, the torque of an associated wheel 140, or the force of an associated wheel 140, while for service brakes 150, the control parameters may include the speed of an associated wheel 140, the slip at an associated wheel 140, the torque of an associated wheel 140, or the force of an associated wheel 140, or a brake pressure.

The actuator limits limₖ may be determined based on a value of an actuator control parameter that may be provided as part of actuator status messages U_{k,stat}. For example, if an electrical machine 120 is too hot and the vehicle speed is 40 km/h, the minimum speed may be limited to 35 km/h to limit braking and maintain the health of the electrical machine 120 The actuator limits limₖ may also be determined based on the unit limits limᵢ. For example, a longitudinal velocity limit of 40 km/h sent from the combination control allocator 210 to the unit control allocator 212 of a unit 110 may correspond to an electrical machine rotational speed limit of 1000 RPM. This may be determined by the unit control allocator 212 based on, for example, wheel radius, gear ratios, etc. In some examples, the unit control allocators 212 may simply forward the unit limits limᵢ to the actuators, for example if the combination control allocator 210 sends an electrical machine rotational speed limit to the unit control allocator 212 The actuator limits limₖ may be determined to be within the actuator capabilities u_{k,cap}. For example, if U_{k,cap} specifies a longitudinal velocity capability between 35 km/h and 40 km/h (in a vehicle speed domain), and limᵢ specifies a minimum limit of 30 km/h, the unit control allocator 212 may modify that limit such that a minimum limit of 35 km/h is set in limₖ. The actuators may then implement the actuator-specific allocated control inputs uₖ based on the actuator limits limₖ. For example, an electrical machine 120 may receive a requested torque as part of an actuator-specific allocated control input uₖ and a maximum velocity for the unit 110 as part of the actuator limits limₖ, and resolve the requested torque to not exceed the maximum velocity.

The limits that are actually set by the unit control allocators 212 and the actuators may differ from those that are received from the combination control allocator 210 and the unit control allocators 212 respectively. For example, a unit control allocator 212 may provide more complex control than the combination control allocator 210 to take more variable into consideration. For example, an anti-roll-over function may be applied in a unit control allocator 212 Therefore, it may be desired that the unit control allocators 212 can override the limits received from the combination control allocator 210 In another example, the unit control allocators 212 may send requests more frequently than the combination control allocator 210 (e.g. every 100 ms vs every 10 ms), meaning that the unit control allocators 212 may need to handle issues (e.g. safety problems) that arise between combination control allocator 210 requests. Similarly, in the case that an actuator cannot fulfil a request from the combination control allocator 210, a unit control allocator 212 can be used to fulfil the actuator capabilities.

Therefore, the unit control allocators 212 and the actuators may also be configured to provide values of previously set limits to the previous level of the control system 200 For example, the actuators may send values of the previously set actuator limits limₖ to the unit control allocators 212 Similarly, the unit control allocators 212 may send values of the previously set unit limits limᵢ to the combination control allocator 210 The unit limits limᵢ that are actually set by the unit control allocators 212 may be based on the actuator limits limₖ that are actually set by the actuators. These messages are therefore status messages rather than implementation requests. In FIG. 3, these messages are shown as limits limᵢ(t−1), limₖ(t−1) at a previous time step to the limits limᵢ(t), limₖ(t) provided in a “forward” sense by the combination control allocator 210 and the unit control allocators 212 This is merely to differentiate between the two signals. It will be appreciated that the limits that are actually set by the unit control allocators 212 and the actuators may be fed back at any suitable time.

FIG. 4 is a flow chart of a computer-implemented method 400 according to an example. The method 400 is for determining and providing upper and lower limits for a control parameter of one or more units of a vehicle combination, such as the vehicle combination 100 The method 400 enables different limits to be set for different units, which may be advantageous in some particular scenarios. The method 400 may be implemented by processing circuitry of a computer system (e.g., the combination control allocator 210 of the control system 200 described in relation to FIGS. 2 and 3).

At 402 a longitudinal velocity of the vehicle combination 100 is acquired. This may be the longitudinal velocity of any or all of the units 110 of the vehicle combination 100, but in particular examples may be the longitudinal velocity of the tractor unit 110-1 The longitudinal velocity may be acquired as part of the unit status messages u_{i,stat} received from the unit control allocators 212 or may be determined in another manner, for example from the state estimator 206

At 404, an upper limit and/or a lower limit limᵢ for a control parameter for at least one unit 110 of the vehicle combination 100 is determined. The control parameter may be a longitudinal slip associated with a unit 110, a longitudinal velocity associated with a unit 110, and/or a rotational speed of an electrical machine 120 associated with a unit 110

The upper and/or lower limit is determined based on the longitudinal velocity acquired at 402 In particular, the upper and/or lower limit may be determined based on a desired outcome, for example improved stability or efficiency of the vehicle combination 100 For example, in order to provide a desired outcome, and increase or decrease to the longitudinal velocity of the vehicle combination 100 may be required, meaning that the velocity limits should be set relative to the current longitudinal velocity. Similarly, if it is desired that the velocity limits do not compromise performance of the vehicle combination 100, then they can be set in a relaxed manner relative to the current longitudinal velocity. If it is desired to control the force of the of the vehicle combination 100, then the measured velocity and set velocity limits can be used to determine slip limits, which implicitly take the longitudinal velocity into account. This may be achieved using vehicle and tyre models as known in the art.

In one example, the upper and/or lower limit is determined based on a roll-over prevention operation for the vehicle combination 100 For example, a lower set of limits may be set for the control parameter for a particular trailing unit 110 if it is determined that the unit 110 is about to roll over (e.g. low normal load on the inner wheels or high lateral acceleration of the unit 110). In particular, an upper limit for longitudinal velocity of the unit 110 may be lower than the longitudinal velocity acquired at 402 For example, a longitudinal velocity of the unit 110 should be low enough to enable high slip (deep slip) that causes saturation of the tyre forces of the unit 110 For example, if it is determined that a unit 110 is about to roll over and a longitudinal velocity of 40 km/h is acquired at 402 an upper limit of 35 km/h and a lower limit of 30 km/h for the longitudinal velocity of the unit 110 may be set, which will eventually lead the unit 110 to brake. Due to braking, the lateral acceleration of the unit 110 and lateral force on the tyres will decrease and roll-over will be avoided.

In another example, the upper and/or lower limit is determined based on a stretch braking operation for the vehicle combination 100 Stretch braking is applied to avoid yaw instabilities, for example, during downhill motion of the vehicle combination 100 where increased coupling force between a trailing unit and a tractor unit may lead to jack-knifing. In these cases, the longitudinal velocity of the trailing unit should be set lower than that of the tractor unit (or indeed a preceding trailer unit). Therefore, when a potential yaw instability is detected (e.g. low friction, high curvature, and downhill), appropriate speed limits can be set for the trailing unit to cause stretch braking and stabilize the vehicle combination 100 In particular, an upper limit for longitudinal velocity of the unit 110 may be lower than the longitudinal velocity acquired at 402 For example, if a longitudinal velocity of 40 km/h is acquired at 402, an upper limit of 42 km/h and a lower limit of 38 km/h for the longitudinal velocity of the tractor unit 110-1 may be set, while an upper limit of 36 km/h and a lower limit of 34 km/h for the longitudinal velocity of the trailing unit 110-2 may be set, which will lead to stretch braking.

In another example, the upper and/or lower limit is determined based on a side slip angle of the unit 110 Proper grip and/or stability cannot be maintained in some scenarios if the vehicle combination 100 brakes or propels excessively, as most/all of the force capability is spent for longitudinal forces and there may not be enough lateral force capability available. Therefore, in cases where the side (lateral) slip angle is higher, a longitudinal velocity and/or slip limit can ensure sufficient lateral force capability. The control parameter for a particular unit 110 can therefore be limited as a function of the side slip angle of the unit 110 The combination control allocator 210 can then centrally coordinate the longitudinal velocity and/or slip limits for the individual units 110 on a combination level. For example, for a side slip angle of 2°, it may be desired to limit the longitudinal slip with a margin of 10%. If a longitudinal velocity of 40 km/h is acquired at 402 an upper limit of 44 km/h and a lower limit of 36 km/h will provide the desired 10% slip limits. The concept of controlling longitudinal slip based on a side slip angle is discussed further in detail in PCT application no. PCT/EP2023/075963 filed on 20 Sep. 2023 in the name of Volvo Truck Corporation.

At 406, the upper limit and/or lower limit limᵢ for the control parameter for at least one unit 110 is transmitted to a controller of the unit 110, for example the respective unit control allocator 212 The unit control allocators 212 can then control the actuators accordingly. For example, the unit control allocators 212 may determine actuator-specific allocated control inputs uₖ based on the upper limit and/or lower limit for the control parameter, as discussed above. This may also be performed based on the actuator capabilities U_{k,cap} received by the unit-specific control allocators 212 from the respective actuators.

If the limits are rather generous, then they will not tangibly limit or restrict the motion requested in the requested combination control input V_{comb,req}. For example in a normal driving case (e.g. on asphalt, flat slope, straight line, low or medium force requests), a 10% margin can be applied to the longitudinal velocity acquired at 402 to provide upper and lower limits. For example, for a longitudinal velocity of 40 km/h, upper and lower limits for the longitudinal velocity of the unit 110 will be 44 km/h and 36 km/h respectively. In normal driving, the vehicle combination 100 will not reach these limits and the force requests will be fulfilled.

In a case where it is desired to ensure stability of the vehicle combination 100, the limits may be somewhat more restrictive. In particular, a lower set of limits may be set. For example, if it is determined that a unit 110 is about to roll over and a longitudinal velocity of 40 km/h is acquired at 402 an upper limit of 35 km/h and a lower limit of 30 km/h for the longitudinal velocity of the unit 110 may be set, which will eventually lead the unit 110 to brake. Due to braking, the lateral acceleration of the unit 110 will decrease and roll-over will be avoided. It should be noted that sending a lower limit for the longitudinal velocity of the unit 110 that is too low may cause the wheels to have deep slip, resulting in a loss of traction, saturating the wheel forces, reducing the lateral forces, and eventually leading to avoid roll-over.

At 408, an upper and/or lower capability for the control parameter may be received. For example, a unit control allocator 212 may send unit capabilities u_{i,cap} to the combination control allocator 210, as discussed above. In particular, the unit capabilities u_{i,cap} may include capabilities of a longitudinal slip associated with the unit 110, a longitudinal velocity associated with the unit 110, and/or a rotational speed of an electrical machine 120 associated with the unit 110

At 410, a measured longitudinal velocity for at least one unit 110 may be received. For example, a unit control allocator 212 may send a unit status message u_{i,stat} to the combination control allocator 210, as discussed above. In particular, the unit status message U_{i,stat} may include a measured longitudinal velocity associated with the unit 110

At 412 a previously set upper and/or a lower limit for at least one unit 110 may be received. For example, a unit control allocator 212 may send a previously set upper and/or a lower limit limᵢ(t−1) to the combination control allocator 210, as discussed above. In this way, the combination control allocator 210 may receive information as to whether limits it has preciously sent to the unit control allocators 212 have been properly implemented.

The steps of the method 400 need not be performed in the exact order shown in FIG. 4. In one example, a unit control allocator 212 may send unit capabilities u_{i,cap} to the combination control allocator 210, e.g. 40 km/h for a lower capability of the longitudinal velocity associated with the unit 110, and 70 km/h for an upper capability of the longitudinal velocity associated with the unit 110 Based on these capabilities, and an acquired longitudinal velocity of 55 km/h, the combination control allocator 210 may determine upper and lower limits for the longitudinal velocity associated with the unit 110 of 60 km/h and 50 km/h respectively. These limits may be set by the unit control allocator 212 which may then send a feedback message to the combination control allocator 210 confirming the limits have been set appropriately (or not).

Whilst the method 400 is generally discussed in terms of the communication between a combination control allocator 210 and a single unit 110, it will be appreciated that the method can be applied for one, multiple, or all of the units 110 in a vehicle combination 100 This enables different limits to be set for different units, which may be advantageous in some particular scenarios. For example, by reducing speed limit for a trailing unit to a lower value than its actual speed, trailer roll-over can be avoided. Furthermore, an upper limit for the longitudinal velocity of a trailing unit can be set lower than that of the tractor unit, which enables stretch braking to be performed. Furthermore, different units 110 may have different side slip angles. A unit 110 exhibiting higher side slip should have tighter slip or speed limits, which can be achieved using the method 400

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired.

Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506 The computer system 500 may include at least one computing device having the processing circuitry 502 The system bus 506 provides an interface for system components including, but not limited to, the memory 504 and the processing circuitry 502 The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502 A basic input/output system (BIOS) 512 may be stored in the non-volatile memory 508 and can include the basic routines that help to transfer information between elements within the computer system 500

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518 All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502 In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502 The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (200, 210, 500) comprising processing circuitry (502) configured to: acquire a longitudinal velocity of a vehicle combination (100); determine an upper limit and/or a lower limit for a control parameter for at least one unit (110) of the vehicle combination (100) based on the acquired longitudinal velocity; and transmit the upper and/or lower limit to a controller (212) of the at least one unit (110) of the vehicle combination (100).

Example 2: The computer system (200, 210, 500) of example 1, wherein the acquired longitudinal velocity is the longitudinal velocity of the tractor unit (110-1) of the vehicle combination (100).

Example 3: The computer system (200, 210, 500) of example 1 or 2, wherein the control parameter comprises a longitudinal slip associated with the at least one unit (110), a longitudinal velocity associated with the at least one unit (110), and/or a rotational speed of an electrical machine associated with the at least one unit (110).

Example 4: The computer system (200, 210, 500) of any preceding example, wherein the processing circuitry (502) is configured to determine the upper and/or lower limit based on a roll-over prevention operation for the vehicle combination (100).

Example 5: The computer system (200, 210, 500) of any preceding example, wherein the processing circuitry (502) is configured to determine the upper and/or lower limit based on a stretch braking operation for the vehicle combination (100).

Example 6: The computer system (200, 210, 500) of example 4 or 5, wherein the control parameter comprises a longitudinal velocity associated with the at least one unit (110), and an upper limit for longitudinal velocity is lower than the acquired longitudinal velocity.

Example 7: The computer system (200, 210, 500) of any preceding example, wherein the processing circuitry (502) is configured to determine the upper and/or lower limit based on a side slip angle of the at least one unit (110).

Example 8: The computer system (200, 210, 500) of any preceding example, wherein the processing circuitry (502) is further configured to receive an upper and/or lower capability for the control parameter for the at least one unit (110) of the vehicle combination (100) from the controller (212) of the at least one unit (110); and determine the upper limit and/or lower limit for the control parameter for the at least one unit (110) of the vehicle combination (100) based on the received capability.

Example 9: The computer system (200, 210, 500) of any preceding example, wherein the processing circuitry (502) is further configured to receive a measured longitudinal velocity for the at least one unit (110) of the vehicle combination (110) from the controller (212) of the at least one unit (110).

Example 10: The computer system (200, 210, 500) of any preceding example, wherein the processing circuitry (502) is further configured to receive a previously set upper and/or lower limit for the control parameter from the controller (212) of the at least one unit (110).

Example 11: The computer system (200, 210, 500) of any preceding example, wherein the controller (212) of the at least one unit (110) of the vehicle combination (110) is configured to transmit an upper and/or lower limit for an actuator control parameter to one or more actuators (120, 150) of the at least one unit (110) based on the upper and/or lower limit for the control parameter of the unit (110).

Example 12: A vehicle (100) comprising the computer system (200, 210, 500) of any preceding example.

Example 13: A computer-implemented method (400) comprising: acquiring (402), by processing circuitry (502) of a computer system (200, 210, 500), a longitudinal velocity of a vehicle combination (100); determining (404), by the processing circuitry (502), an upper limit and/or a lower limit for a control parameter for at least one unit (110) of the vehicle combination (100) based on the acquired longitudinal velocity; and transmitting (406), by the processing circuitry (502), the upper and/or lower limit to a controller (212) of the at least one unit (110).

Example 14: The computer-implemented method (400) of example 13, wherein the acquired longitudinal velocity is the longitudinal velocity of the tractor unit (110-1) of the vehicle combination (100).

Example 15: The computer-implemented method (400) of example 13 or 14, wherein the control parameter comprises a longitudinal slip associated with the at least one unit (110), a longitudinal velocity associated with the at least one unit (110), and/or a rotational speed of an electrical machine associated with the at least one unit (110).

Example 16: The computer-implemented method (400) of any of examples 13 to 15, comprising determining the upper and/or lower limit based on a roll-over prevention operation for the vehicle combination (100).

Example 17: The computer-implemented method (400) of any of examples 13 to 16, comprising determining the upper and/or lower limit based on a stretch braking operation for the vehicle combination (100).

Example 18: The computer-implemented method (400) of example 16 or 17, wherein the control parameter comprises a longitudinal velocity associated with the at least one unit (110), and an upper limit for longitudinal velocity is lower than the acquired longitudinal velocity.

Example 19: The computer-implemented method (400) of any of examples 13 to 18, comprising determining the upper and/or lower limit based on a side slip angle of the at least one unit (110).

Example 20: The computer-implemented method (400) of any of examples 13 to 19, further comprising receiving, by the processing circuitry (502), an upper and/or lower capability for the control parameter for the at least one unit (110) of the vehicle combination (100) from the controller (212) of the at least one unit (110); and determining the upper limit and/or lower limit for the control parameter for the at least one unit (110) of the vehicle combination (100) based on the received capability.

Example 21: The computer-implemented method (400) of any of examples 13 to 20, further comprising receiving, by the processing circuitry (502), a measured longitudinal velocity for the at least one unit (110) of the vehicle combination (110) from the controller (212) of the at least one unit (110).

Example 22: The computer-implemented method (400) of any of examples 13 to 21, further comprising receiving, by the processing circuitry (502), a previously set upper and/or lower limit for the control parameter from the controller (212) of the at least one unit (110).

Example 23: The computer-implemented method (400) of any of examples 13 to 22, wherein the controller (212) of the at least one unit (110) of the vehicle combination (110) is configured to transmit an upper and/or lower limit for an actuator control parameter to one or more actuators (120, 150) of the at least one unit (110) based on the upper and/or lower limit for the control parameter of the unit (110).

Example 24: A computer program product comprising program code for performing, when executed by processing circuitry (502), the computer-implemented method (400) of any of examples 13 to 23.

Example 25: A non-transitory computer-readable storage medium comprising instructions, which when executed by processing circuitry (502), cause the processing circuitry to perform the computer-implemented method (400) of any of examples 13 to 23.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
acquire a longitudinal velocity of a vehicle combination;
determine an upper limit and/or a lower limit for a rotational speed of an electrical machine associated with at least one unit of the vehicle combination or a speed of a wheel associated with the electrical machine based on the acquired longitudinal velocity; and
transmit the upper and/or lower limit to a controller of the at least one unit of the vehicle combination.

2. The computer system of claim 1, wherein the acquired longitudinal velocity is the longitudinal velocity of the tractor unit of the vehicle combination.

3. The computer system of claim 1, wherein the processing circuitry is configured to determine the upper and/or lower limit further based on a roll-over prevention operation for the vehicle combination.

4. The computer system of claim 1, wherein the processing circuitry is configured to determine the upper and/or lower limit further based on a stretch braking operation for the vehicle combination.

5. The computer system of claim 1, wherein the processing circuitry is configured to determine the upper and/or lower limit further based on a side slip angle of the at least one unit.

6. The computer system of claim 1, wherein the processing circuitry is further configured to:
receive an upper and/or lower capability for the rotational speed of the electrical machine or the speed of the wheel associated with the electrical machine from the controller of the at least one unit; and
determine the upper limit and/or lower limit based on the received capability.

7. The computer system of claim 1, wherein the processing circuitry is further configured to receive a measured longitudinal velocity for the at least one unit of the vehicle combination from the controller of the at least one unit.

8. The computer system of claim 1, wherein the processing circuitry is further configured to receive a previously set upper and/or lower limit for the rotational speed of the electrical machine or the speed of the wheel associated with the electrical machine from the controller of the at least one unit.

9. A vehicle comprising the computer system of claim 1.

10. A computer-implemented method comprising:
acquiring, by processing circuitry of a computer system, a longitudinal velocity of a vehicle combination;
determining, by the processing circuitry, an upper limit and/or a lower limit for a rotational speed of an electrical machine associated with at least one unit of the vehicle combination or a speed of a wheel associated with the electrical machine based on the acquired longitudinal velocity; and
transmitting, by the processing circuitry, the upper and/or lower limit to a controller of the at least one unit.

11. The computer-implemented method of claim 10, wherein the acquired longitudinal velocity is the longitudinal velocity of the tractor unit of the vehicle combination.

12. The computer-implemented method of claim 10, comprising determining the upper and/or lower limit based on a roll-over prevention operation for the vehicle combination.

13. The computer-implemented method of claim 10, comprising determining the upper and/or lower limit based on a stretch braking operation for the vehicle combination.

14. The computer-implemented method of claim 10, comprising determining the upper and/or lower limit based on a side slip angle of the at least one unit.

15. The computer-implemented method of claim 10, further comprising:
receiving, by the processing circuitry, an upper and/or lower capability for the rotational speed of the electrical machine or the speed of the wheel associated with the electrical machine from the controller of the at least one unit; and
determining the upper limit and/or lower limit based on the received capability.

16. The computer-implemented method of claim 10, further comprising receiving, by the processing circuitry, a measured longitudinal velocity for the at least one unit of the vehicle combination from the controller of the at least one unit.

17. The computer-implemented method of claim 10, further comprising receiving, by the processing circuitry, a previously set upper and/or lower limit for the rotational speed of the electrical machine or the speed of the wheel associated with the electrical machine from the controller of the at least one unit.

18. A computer program product comprising program code for performing, when executed by processing circuitry, the computer-implemented method of claim 10.

19. A non-transitory computer-readable storage medium comprising instructions, which when executed by processing circuitry, cause the processing circuitry to perform the computer-implemented method of claim 10.
